(19) United States
(12) Patent Application Publication
(10) Pub. No.: US 2026/0363163 A1
(43) Pub. Date: Nov. 19, 2026

(54) DOUBLE-TRACK SEEDLING SEPARATING DEVICE FOR TRANSPLANTER AND OPERATION METHOD THEREFOR

(71) Applicant: Henan University of Science and Technology, Luoyang (CN)

(72) Inventors: Xin JIN, Luoyang (CN); Xingguang CHEN, Luoyang (CN); Mingyong LI, Luoyang (CN); Liqiang XIAO, Luoyang (CN); Wenshen PAN, Luoyang (CN); Xiaolin XIE, Luoyang (CN); Shuang CHEN, Luoyang (CN); Xiaowu ZHU, Luoyang (CN); Linyong ZHOU, Luoyang (CN)

(73) Assignee: Henan University of Science and Technology, Luoyang (CN)

(21) Appl. No.: 19/731,616

(22) Filed: Jul. 6, 2026

Related U.S. Application Data
(63) Continuation-in-part of application No. PCT/CN2025/130446, filed on Oct. 28, 2025.

(30) Foreign Application Priority Data
Oct. 31, 2024 (CN) 202411541599.X

(51) Int. Cl. A01C 11/00

(52) U.S. Cl. CPC A01C 11/006

(57) ABSTRACT

A double-track seedling separating device for a transplanter includes a seedling separating frame and a seedling supplement frame. An endless conveyor belt is arranged on the seedling separating frame. A plurality of seedling containing mechanisms are placed on the endless conveyor belt. A detection mechanism is arranged on the seedling separating frame, right above a moving path of the seedling containing mechanism to detect whether the seedling containing mechanism located right below the detection mechanism lacks seedlings. A U-shaped conveyor belt is arranged on the seedling supplement frame, has an input end and an output end which are separately connected to the endless conveyor belt through symmetrically arranged a first blocking and pushing mechanism and a second blocking and pushing mechanism. A manual supplement position is provided on one side of the U-shaped conveyor belt to manually supplement seedlings to the seedling containing mechanism that lacks seedlings.

### CROSS-REFERENCE TO RELATED APPLICATIONS

This application is a continuation in part of International Application No. PCT/CN2025/130446, filed on Oct. 28, 2025, which claims the benefit of priority to Chinese Patent Application No. 202411541599.X, filed to the China National Intellectual Property Administration on Oct. 31, 2024. The entire content of both applications is incorporated herein by reference.

### TECHNICAL FIELD

The present disclosure relates to the technical field of transplanters, and in particular, to a double-track seedling separating device for a transplanter and an operation method therefor.

### BACKGROUND

Seedling raising and transplanting is a common operation approach in agricultural production. Using this approach, natural factors affecting the seedling such as low temperature and frost are effectively avoided, plant diseases and insect pests are reduced, and survival rate and quality of crops can be effectively improved. A fully automatic transplanter can improve transplanting efficiency and transplanting quality, reduce labor intensity of workers and production costs, and is a development direction of vegetable transplanting.

During an operation process of fully automatic transplanting, situations of lacking seedlings and missing planting may occur due to reasons such as growth conditions of seedlings, failure in seedling pickup and dropping, and seedling damage. Missing planting may lead to uneven crop growth, decreased yield, waste of land resources, and an increase in labor costs in a later period, and may affect mechanized management of crops in the later period.

### SUMMARY

In view of problems existing in the existing technology, the present disclosure provides a double-track seedling separating device for a transplanter and an operation method therefor.

A technical solution used in the present disclosure to solve the foregoing technical problems is to provide a double-track seedling separating device for a transplanter. The double-track seedling separating device includes a seedling separating frame and a seedling supplement frame; an endless conveyor belt arranged on the seedling separating frame, wherein the endless conveyor belt is racetrack-shaped; a plurality of seedling containing mechanisms placed on the endless conveyor belt; a detection mechanism arranged on the seedling separating frame, wherein the detection mechanism is arranged right above a moving path of the seedling containing mechanism, and the detection mechanism is configured to detect whether the seedling containing mechanism located right below the detection mechanism lacks seedlings; wherein the seedling containing mechanism includes a seedling cup configured to store a seedling; a seedling outlet provided at a lower end of the seedling cup, wherein the seedling outlet is located on an outer side of the endless conveyor belt, and a cover portion is arranged at the seedling outlet of the seedling cup; a flipping mechanism arranged on the seedling cup and configured to drive the cover portion to open or close the seedling outlet; and a U-shaped conveyor belt arranged on the seedling supplement frame, wherein the U-shaped conveyor belt has an input end and an output end, the input end and the output end of the U-shaped conveyor belt are separately connected to the endless conveyor belt through a first blocking and pushing mechanism and a second blocking and pushing mechanism, wherein the first blocking and pushing mechanism and the second blocking and pushing mechanism are symmetrically arranged, the first blocking and pushing mechanism is configured to block the seedling containing mechanism that lacks seedlings on the endless conveyor belt and push and transfer the seedling containing mechanism that lacks seedlings to the U-shaped conveyor belt, a manual supplement position is provided on one side of the U-shaped conveyor belt, the manual supplement position is configured to manually supplement seedlings to the seedling containing mechanism that lacks seedlings, and the second blocking and pushing mechanism is configured to block the seedling containing mechanism that is supplemented with the seedlings on the endless conveyor belt, and push and transfer the seedling containing mechanism that is supplemented with the seedlings to the endless conveyor belt.

In some embodiments, the detection mechanism includes a mounting truss arranged on the seedling separating frame, a fixed bracket arranged on the mounting truss, and a detection camera arranged at a lower end of the fixed bracket, the detection camera is connected to a controller, and the detection camera can take a photo of the seedling containing mechanism located below the detection camera, to enable the controller to identify whether the seedling containing mechanism lacks seedlings.

In some embodiments, the seedling containing mechanism includes a seedling cup fixing plate, two wheel axles arranged at a lower end of the seedling cup fixing plate, and wheels fixedly arranged at lower ends of the wheel axles, and a mounting slot for mounting the seedling cup is provided on the seedling cup fixing plate.

In some embodiments, the cover portion includes two cover plates hinged at the seedling outlet, the flipping mechanism includes a cover opening motor and a connecting rod component arranged on an inner side of the seedling cup, a partition configured to divide an inner cavity of the seedling cup into an accommodating cavity and a connecting rod cavity is arranged in the seedling cup, the accommodating cavity is configured to accommodate the seedlings, the connecting rod component is located in the connecting rod cavity, the connecting rod component includes a crank arranged at an output shaft of the cover opening motor, a connecting rod is hinged to the cover plate, and both the connecting rods are hinged to the crank.

In some embodiments, the first blocking and pushing mechanism and the second blocking and pushing mechanism are of the same structure and size, the first blocking and pushing mechanism includes a blocking component, a first push component, a second push component, and a track change component, the first push component is arranged on the blocking component, and the blocking component has two states of blocking and passing; in the blocking state, the blocking component blocks the seedling containing mechanism, the first push component is configured to push the seedling containing mechanism to the second push component, the second push component is configured to push the seedling containing mechanism to the track change component, and the track change component is configured to transfer the seedling containing mechanism to the U-shaped conveyor belt; and when the seedlings are placed, the seedling containing mechanism can pass through the blocking component.

In some embodiments, the blocking component includes two blocking pieces that are arranged opposite to each other, the blocking piece includes a vertical moving module, blocking plates are hinged to the vertical moving module, first arc-shaped slots are oppositely provided on the two blocking plates, the two first arc-shaped slots form a first arc-shaped groove that cooperates with the wheel axles, the vertical moving module includes a chute boss, a lead screw motor, a lead screw, and a sliding block, the lead screw is rotatably arranged on the chute boss, the lead screw motor is configured to drive the lead screw to rotate, the sliding block is slidably arranged on the chute boss and is in threaded connection with the lead screw, a connecting plate is hinged between the sliding block and the blocking plate, the first push component includes a micro cylinder arranged on the blocking plate, an arc-shaped push block is arranged at an end of a piston rod of the micro cylinder, the arc-shaped push block has second arc-shaped slots, and the two second arc-shaped slots form a second arc-shaped groove that cooperates with the wheel axles.

In some embodiments, the second push component includes a fixed bottom plate, a T-shaped plate slidably arranged on the fixed bottom plate, and a push cylinder configured to drive the T-shaped plate to move horizontally, a T-shaped plate is arranged on a bearing plate, a horizontal moving module perpendicular to the T-shaped plate is arranged on the T-shaped plate, two horizontal moving modules are provided, the horizontal moving modules are arranged parallel to the fixed bottom plate, a claw that cooperates with the wheel axle is arranged on the horizontal moving module, and the claw is in a semicircular shape.

In some embodiments, the track change component includes a horizontal conveyor belt.

This application further provides an operation method for a double-track seedling separating device for a transplanter by using the double-track seedling separating device for a transplanter. The method includes the following steps:
S1: placing the plurality of seedling containing mechanisms on the endless conveyor belt, and detecting, by using the detection mechanism, whether the seedling containing mechanism located right below the detection mechanism lacks seedlings;
S2: when lack of seedlings is not detected by the detection mechanism, continuously conveying, by using the endless conveyor belt, the seedling containing mechanism; when lack of seedling is detected by the detection mechanism, blocking, by using the first blocking and pushing mechanism, the seedling containing mechanism that lacks seedlings on the endless conveyor belt, pushing and transferring the seedling containing mechanism that lacks seedlings to the U-shaped conveyor belt, and then manually supplementing seedlings to the seedling containing mechanism that lacks seedlings; after the seedlings are supplemented, blocking, by using the second blocking and pushing mechanism, the seedling containing mechanism that is supplemented with the seedlings on the endless conveyor belt, and pushing and transferring the seedling containing mechanism that is supplemented with the seedlings to the endless conveyor belt; and
S3: after the endless conveyor belt conveys the seedling containing mechanism to an appropriate position, opening the seedling outlet by using the flipping mechanism, to complete seedling dropping of the transplanter.

Beneficial effects of this application are as follows: The present disclosure abandons a conventional chain-type hanging cup seedling separating mechanism, uses a double-track flexible conveying mechanism, has a wide adaptation range, and can effectively prevent a phenomenon of seedling lack and missing planting in an operation process of a fully automatic transplanter, thereby improving quality and efficiency of a transplanting operation.

Further, whether the seedling containing mechanism lacks seedlings is detected by using the detection mechanism, then the first blocking and pushing mechanism blocks the seedling containing mechanism that lacks seedlings on the endless conveyor belt, and pushes the seedling containing mechanism that lacks seedlings to the U-shaped conveyor belt, and the second blocking and pushing mechanism blocks the seedling containing mechanism that is supplemented with the seedlings on the endless conveyor belt, and pushes and transfers the seedling containing mechanism that is supplemented with the seedlings to the endless conveyor belt, thereby rapidly implementing track change and seedling supplement of the seedling containing mechanism, and effectively avoiding missing seedlings.

### BRIEF DESCRIPTION OF THE DRAWINGS

FIG. 1 is an axonometric view of a double-track seedling separating device for a transplanter according to a first embodiment of the present disclosure;

FIG. 2 is another axonometric view of the double-track seedling separating device for a transplanter according to the first embodiment of the present disclosure;

FIG. 3 is an axonometric diagram of a seedling containing mechanism of the double-track seedling separating device for a transplanter according to the first embodiment of the present disclosure;

FIG. 4 is an axonometric view of a seedling cup of the double-track seedling separating device for a transplanter according to the first embodiment of the present disclosure;

FIG. 5 is a cross-sectional view of the seedling cup of the double-track seedling separating device for a transplanter according to the first embodiment of the present disclosure;

FIG. 6 is an axonometric view of a blocking component of the double-track seedling separating device for a transplanter according to the first embodiment of the present disclosure;

FIG. 7 is a front view of the blocking component in an open state according to the first embodiment of the present disclosure;

FIG. 8 is an axonometric diagram of a second push component of the double-track seedling separating device for a transplanter according to the first embodiment of the present disclosure;

FIG. 9 is an axonometric diagram of a track change component of the double-track seedling separating device for a transplanter according to a second embodiment of the present disclosure;

FIG. 10 is an axonometric diagram of a positioning mechanism of the double-track seedling separating device for a transplanter according to the second embodiment of the present disclosure; and

FIG. 11 is a schematic diagram of a double-track seedling separating device for a transplanter, illustrating electrical connections among components according to an embodiment of the present disclosure.

### REFERENCE SIGNS IN ACCOMPANYING DRAWINGS

1, endless conveyor belt, 2, seedling containing mechanism, 201, seedling cup, 202, cover opening motor, 203, seedling cup fixing plate, 204, wheel, 205, wheel axle, 206, limiting groove, 207, partition, 208, cover plate, 209, connecting rod, 210, crank, 3, seedling separating frame, 4, image collection position sensor, 5, first push component, 6, track change component, 601, reversing plate, 602, limiting portion, 603, guide wheel, 604, rectangular hole, 605, positioning cylinder, 606, connecting plate, 607, synchronous belt module, 608, fixed plate, 609, sliding shaft, 610, guide bushing, 7, seedling supplement frame, 8, second guide edge, 9, U-shaped conveyor belt, 10, second push component, 1001, fixed bottom plate, 1002, linear guide track, 1003, slider, 1004, bearing seat, 1005, screw, 1006, claw, 1007, sliding claw, 1008, hinge rod, 1009, micro electric push rod, 1010, first coupling, 1011, screw motor, 1012, T-shaped plate, 1013, push cylinder, 11, blocking piece, 1101, lead screw motor, 1102, second coupling, 1103, lead screw, 1104, chute boss, 1105, connecting plate, 1106, sliding block, 1107, blocking plate, 1108, micro cylinder, 1109, cylinder fixing frame, 1110, arc-shaped push block, 12, transverse plate, 13, mounting truss, 14, fixed bracket, 15, detection camera, 16, seedling dropping position sensor, and 17, first guide edge.

### DETAILED DESCRIPTION

In order to make purposes, technical solutions, and advantages of the present disclosure clearer, the present disclosure will be further described in detail below with reference to accompanying drawings and the embodiments. It is to be noted that, in the descriptions of the present disclosure, unless otherwise specified, “a plurality of” means two or more; orientations or positional relationships indicated by terms “upper”, “lower”, “left”, “right”, “inner”, “outer”, “front end”, “rear end”, “head”, “tail”, and the like are the orientations or positional relationships shown based on the accompanying drawings, and merely facilitate describing the present disclosure and simplifying the description, rather than indicating or implying that the referred devices or elements need to have particular orientations, and constructed and operated in particular orientations. Thus, it cannot be construed as a limitation to the present disclosure. In addition, terms “first”, “second”, “third”, and the like are merely used for description, and cannot be understood as indicating or implying relative importance.

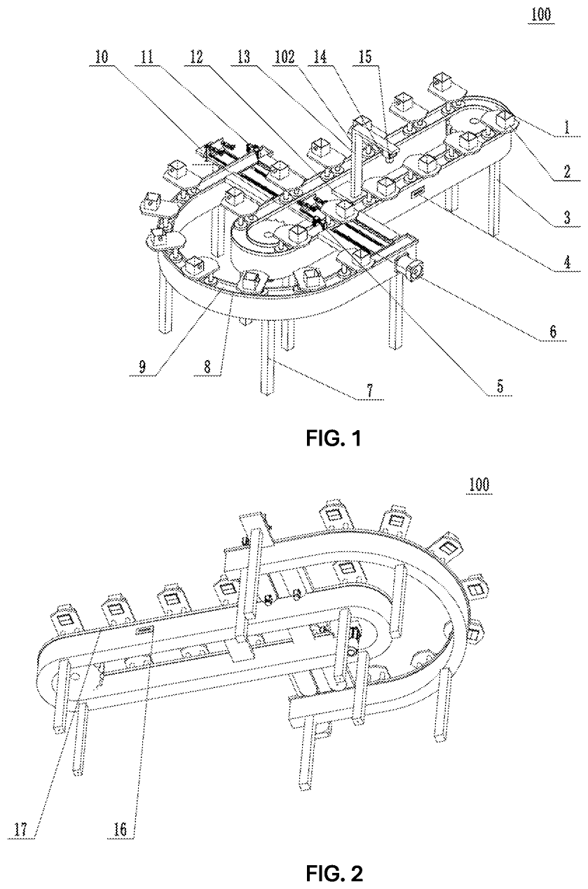

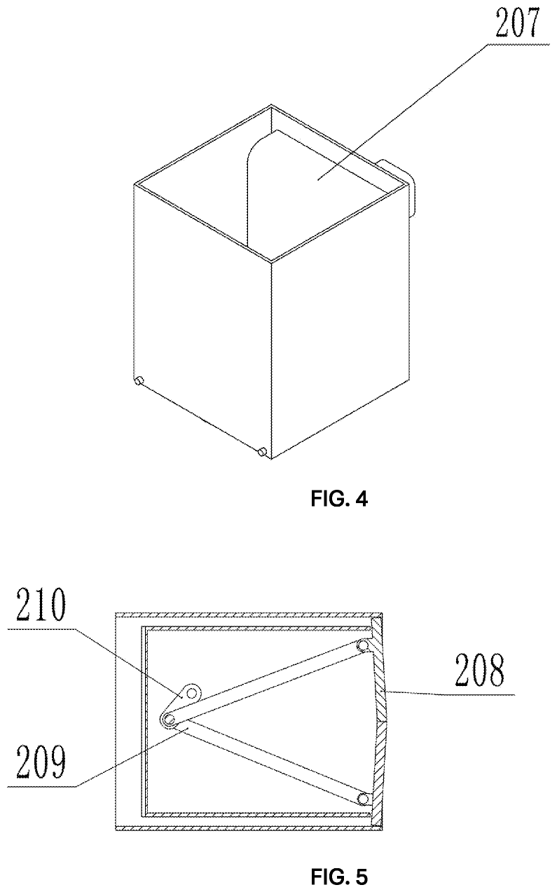

Referring to FIG. 1 to FIG. 8, a first embodiment of the present disclosure provides a double-track seedling separating device for a transplanter. The double-track seedling separating device 100 is configured for a transplanter. Referring to FIG. 1 and FIG. 2, the double-track seedling separating device 100 includes a seedling separating frame 3 and a seedling supplement frame 7. An endless conveyor belt 1 is arranged on the seedling separating frame 3, and the endless conveyor belt 1 is racetrack-shaped. A plurality of seedling containing mechanisms 2 are placed on the endless conveyor belt 1. A detection mechanism 102 is further arranged on the seedling separating frame 3. The detection mechanism is arranged right above a moving path of the seedling containing mechanism 2, and the detection mechanism is configured to detect whether the seedling containing mechanism 2 located right below the detection mechanism lacks seedlings. In some embodiment, the detection mechanism includes a detection camera 15. The seedling containing mechanism 2 includes a seedling cup 201 configured to store a seedling. A seedling outlet is provided at a lower end of the seedling cup 201, the seedling outlet is located on an outer side of the endless conveyor belt 1. A cover portion is arranged at the seedling outlet of the seedling cup 201, and a flipping mechanism configured to drive the cover portion to open or close the seedling outlet is arranged on the seedling cup 201 A U-shaped conveyor belt 9 is arranged on the seedling supplement frame 7. The U-shaped conveyor belt 9 has an input end and an output end, the input end and the output end of the U-shaped conveyor belt 9 are separately connected to the endless conveyor belt 1 through a first blocking and pushing mechanism and a second blocking and pushing mechanism, the first blocking and pushing mechanism and the second blocking and pushing mechanism are symmetrically arranged, the first blocking and pushing mechanism is configured to block the seedling containing mechanism 2 that lacks seedlings on the endless conveyor belt 1 and push and transfer the seedling containing mechanism 2 that lacks seedlings to the U-shaped conveyor belt 9. A manual supplement position is provided on one side of the U-shaped conveyor belt 9, and the manual supplement position is configured to manually supplement seedlings to the seedling containing mechanism 2 that lacks seedlings; and the second blocking and pushing mechanism is configured to block the seedling containing mechanism 2 that is supplemented with the seedlings on the endless conveyor belt 1, and push and transfer the seedling containing mechanism 2 that is supplemented with the seedlings to the endless conveyor belt 1.

When the seedling containing mechanism 2 is located on the U-shaped conveyor belt 9, the seedling outlet of the seedling cup 201 is located on an outer side of the U-shaped conveyor belt 9. The endless conveyor belt 1 includes a first conveyor belt and a first conveying motor that is arranged on the seedling separating frame 3 and that can drive the first conveyor belt to move. Alternatively, the endless conveyor belt 1 may use a conveyor belt that is commonly used in the conventional technology and that is in an annular deployment. The U-shaped conveyor belt 9 is U-shaped and includes a second conveyor belt and a second conveying motor that is arranged on the seedling supplement frame 7 and that can drive the second conveyor belt to move. The U-shaped conveyor belt 9 may use a conveyor belt that is commonly used in the conventional technology and that is in a U-shaped deployment. In some embodiments, the endless conveyor belt 1 and the U-shaped conveyor belt 9 may use a conveyor belt with the configurations similar to those disclosed in CN219278503U. The endless belt 1 has two straight line portions and two semicircular portions. The two straight line portions are located between the input end and the output end of the U-shaped conveyor belt 9.

Continuing with FIG. 1 and FIG. 2, the endless conveyor belt 1 has a racetrack-shaped first conveying surface, and racetrack-shaped first guide edges 17 are arranged on two sides of the first conveying surface on the seedling separating frame 3. The U-shaped conveyor belt 9 has a U-shaped second conveying surface, and U-shaped second guide edges 8 are arranged on two sides of the first conveying surface on the seedling supplement frame 7. First gaps for the seedling containing mechanism 2 to pass through are symmetrically provided on the U-shaped second guide edge 8 located on an inner side of the seedling supplement frame 7. One of the two gaps is the input end of the U-shaped conveyor belt 9, and the other is the output end of the U-shaped conveyor belt 9. Second gaps that are corresponding to the first gaps and are configured for the seedling containing mechanism 2 to pass through are provided on the first guide edge 17 located on an outer side of the seedling separating frame 3.

With reference to FIG. 1, the detection mechanism 102 includes a mounting truss 13 arranged on the seedling separating frame 3, a fixed bracket 14 arranged on the mounting truss 13, and a detection camera 15 arranged at a lower end of the fixed bracket 14, a transverse plate 12 is arranged on the seedling separating frame 3 and is located on an inner side of the endless conveyor belt 1, the mounting truss 13 is fixed to an upper end of the transverse plate 12, the mounting truss 13 has a vertical portion fixedly connected to the transverse plate 12 and a horizontal portion connected to the vertical portion, and the fixed bracket 14 is fixedly mounted at a lower end of the horizontal portion.

An image collection position sensor 4 and a seedling dropping position sensor 16 are respectively arranged on two sides of the endless conveyor belt 1 on the seedling separating frame 3, and the image collection position sensor 4 is arranged close to the mounting truss 13.

The detection camera 15 is connected to a controller. The detection camera 15 takes a photo of the seedling containing mechanism 2 located below the detection camera 15 for the identification on whether the seedling containing mechanism 2 lacks seedlings. The controller is communicated with the detection camera 15 and receives the images from the detection camera 15 to determine whether the seedling containing mechanism 2 lacks seedlings. The controller is electrically connected to each of the flipping mechanism, the image collection position sensor 4, the seedling dropping position sensor 16, the detection camera 15, the endless conveyor belt 1, the U-shaped conveyor belt 9, the first blocking and pushing mechanism, and the second blocking and pushing mechanism.

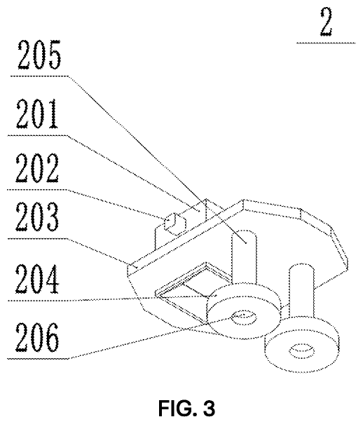

With reference to FIG. 3 to FIG. 5, the seedling containing mechanism 2 includes a seedling cup fixing plate 203, two wheel axles 205 arranged at a lower end of the seedling cup fixing plate 203, and wheels 204 fixedly arranged at lower ends of the wheel axles 205, and a mounting slot for mounting the seedling cup 201 is provided on the seedling cup fixing plate 203. The seedling cup fixing plate 203 is fixed at the mounting slot. The cover portion includes two cover plates 208 hinged at the seedling outlet. The flipping mechanism includes a cover opening motor 202 and a connecting rod component arranged on an inner side of the seedling cup 201. A partition 207 configured to divide an inner cavity of the seedling cup 201 into an accommodating cavity and a connecting rod cavity is arranged in the seedling cup 201. The accommodating cavity is configured to accommodate the seedlings, and the connecting rod component is located in the connecting rod cavity. The partition 207, in an aspect, prevents the seedlings from falling into the connecting rod component to cause seedling damage, and in another aspect, prevents dust pollution from affecting operations. The connecting rod component includes a crank 210 arranged at an output shaft of the cover opening motor 202, a connecting rod 209 is hinged to the cover plate 208, and both the connecting rods 209 are hinged to the crank 210. The cover opening motor 202 drives the crank 210 to move, to drive the connecting rod 209 to move, thereby implementing opening and closing actions of the cover plate 208.

Turning to FIG. 1, the first blocking and pushing mechanism and the second blocking and pushing mechanism are of the same structure and size. The first blocking and pushing mechanism includes a blocking component, a first push component 5, a second push component 10, and a track change component 6, the first push component 5 is arranged on the blocking component, and the blocking component has two states of blocking and passing. In the blocking state, the blocking component blocks the seedling containing mechanism 2, the first push component 5 is configured to push the seedling containing mechanism 2 to the second push component 10, the second push component 10 is configured to push the seedling containing mechanism 2 to the track change component 6, and the track change component 6 is configured to transfer the seedling containing mechanism 2 to the U-shaped conveyor belt 9. When the seedlings are placed, the seedling containing mechanism 2 can pass through the blocking component; and the track change component 6 is mounted between a first gap and a second gap that are opposite to each other.

The blocking component and the second push component 10 of the first blocking and pushing mechanism are located on the seedling separating frame 3. The blocking component of the first blocking and pushing mechanism is located behind the detection mechanism. The blocking component and the second push component 10 of the second blocking and pushing mechanism are located on the seedling supplement frame 7. The track change component 6 of the second blocking and pushing mechanism is configured to transfer the seedling containing mechanism 2 on the U-shaped conveyor belt 9 to the endless conveyor belt 1.

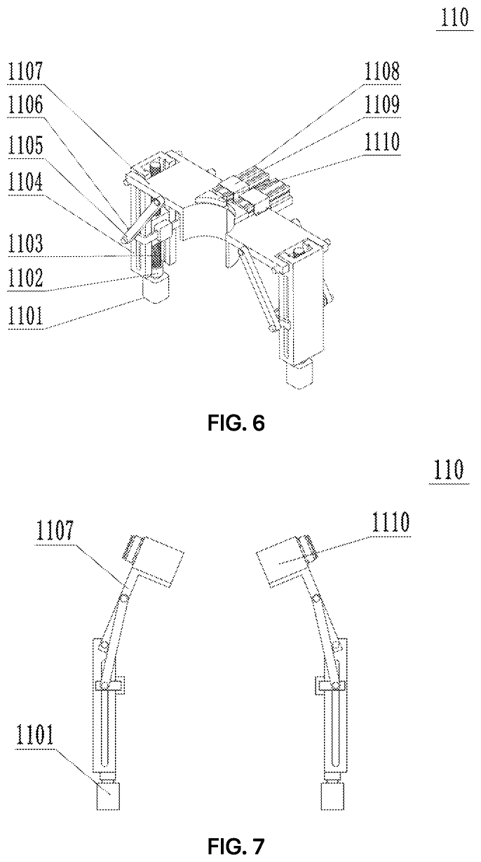

With reference to FIG. 6 and FIG. 7, the blocking component 110 includes two blocking pieces 11 that are arranged opposite to each other. The blocking piece 11 includes a vertical moving module, and a blocking plate 1107 is hinged to the vertical moving module. The two blocking plates 1107 are arranged opposite to each other. First arc-shaped slots are oppositely provided on the two blocking plates 1107. The two first arc-shaped slots form a first arc-shaped groove that cooperates with the wheel axles 205. The first arc-shaped groove is semicircular. The vertical moving module includes a chute boss 1104, a lead screw motor 1101, a lead screw 1103, and a sliding block 1106. The lead screw 1103 is rotatably arranged on the chute boss 1104. The lead screw motor 1101 is configured to drive the lead screw 1103 to rotate. The lead screw motor 1101 is connected to the lead screw 1103 through a second coupling 1102. The sliding block 1106 is slidably arranged on the chute boss 1104 and is in threaded connection with the lead screw 1103. Horizontal rods are respectively arranged on two sides of the sliding block 1106. A kidney-shaped long hole for the horizontal rod to slide up and down is provided in the chute boss 1104. A U-shaped frame is arranged on the sliding block 1106. The U-shaped frame is fixedly connected to each of the two horizontal rods. Connecting plates 1105 are hinged between the sliding block 1106 and the blocking plate 1107. Two connecting plates 1105 are arranged and are respectively located on the two sides of the sliding block 1106. One end of the connecting plate 1105 is hinged to the horizontal rod on the same side, and the other end is hinged to the blocking plate 1107. The first push component 5 includes a micro cylinder 1108 arranged on the blocking plate 1107. The micro cylinder 1108 is mounted on the blocking plate 1107 through a cylinder fixing frame 1109. The cylinder fixing frame 1109 is U-shaped and has a mounting slot that cooperates with the micro cylinder 1108. The cylinder fixing frame 1109 is mounted on the blocking plate 1107 by bolts. An arc-shaped push block 1110 is arranged at an end of a piston rod of the micro cylinder 1108. The arc-shaped push block 1110 has second arc-shaped slots, and the two second arc-shaped slots form a second arc-shaped groove that cooperates with the wheel axles 205.

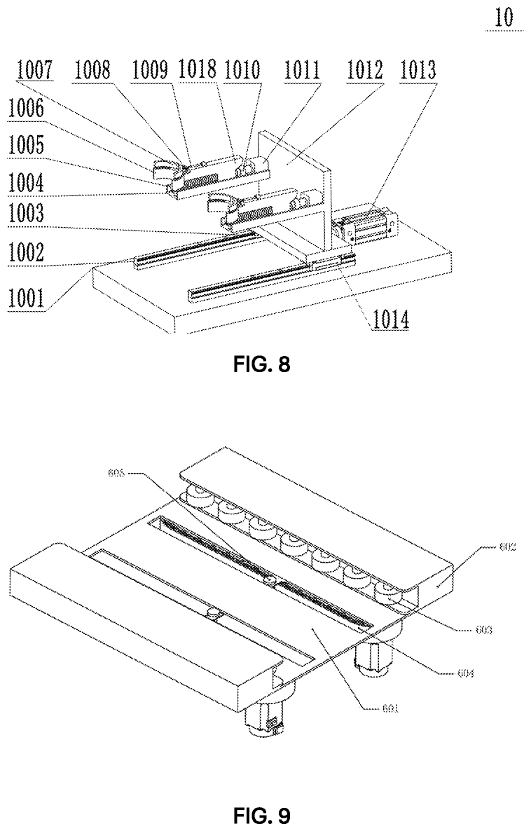

With reference to FIG. 8, the second push component 10 includes a fixed bottom plate 1001, a T-shaped plate 1012 slidably arranged on the fixed bottom plate 1001, and a push cylinder 1013 configured to drive the T-shaped plate 1012 to move horizontally. Two linear guide tracks 1002 are arranged on the fixed bottom plate 1001. A slider 1003 is slidably arranged on the linear guide track 1002. A bearing plate 1014 is fixed to the slider 1003. The T-shaped plate 1012 is arranged on the bearing plate 1004. A horizontal moving module perpendicular to the T-shaped plate 1012 is arranged on the T-shaped plate. Two horizontal moving modules are provided and the horizontal moving modules are arranged parallel to the fixed bottom plate 1001. A claw 1006 that cooperates with the wheel axle 205 is arranged on the horizontal moving module. The claw 1006 is semicircular.

The T-shaped plate has a horizontal end and a vertical end. The horizontal moving module 120 is vertically fixed to the vertical end. The horizontal moving module includes a screw 1005, a screw motor 1011 configured to drive the screw 1005 to rotate, a bearing seat 1004 fixedly connected to the vertical end, and a 7-shaped seat slidably 1018 arranged on the bearing seat 1004. The screw 1005 is connected to the screw motor 1011 through a first coupling 1010. The 7-shaped seat 1018 includes a vertical connecting portion and a horizontal positioning portion. The vertical connecting portion is slidably connected to the bearing seat 1004. A chute that is in sliding fit with the vertical connecting portion is arranged on the bearing seat 1004. The vertical connecting portion is in threaded connection with the screw 1005. A threaded hole that cooperates with the screw 1005 is provided in the vertical connecting portion. The claw 1006 is fixed to an end of the horizontal positioning portion.

The track change component 6 includes a horizontal conveyor belt and a third conveying motor configured to drive the horizontal conveyor belt to move. The track change component 6 further includes a conveyor belt holder. Both the horizontal conveyor belt and the third conveying motor are mounted on the conveyor belt holder. The conveyor belt holder is mounted between the first gap and the second gap that are opposite to each other. The horizontal conveyor belt may use an existing conveyor belt that is commonly used.

An operation method for a double-track seedling separating device for a transplanter by using the double-track seedling separating device for a transplanter includes the following steps:
S1: place the plurality of seedling containing mechanisms 2 on the endless conveyor belt 1, and the detection camera on the detection mechanism detects whether the seedling containing mechanism 2 located right below the detection mechanism lacks seedlings;
S2: when lack of seedling is not detected by the detection mechanism, the endless conveyor belt 1 continuously conveys the seedling containing mechanism 2; when lack of seedling is detected by the detection mechanism, the first blocking and pushing mechanism blocks the seedling containing mechanism 2 that lacks seedlings on the endless conveyor belt 1, pushes and transfers the seedling containing mechanism 2 that lacks seedlings to the U-shaped conveyor belt 9, and then seedlings are manually supplemented to the seedling containing mechanism 2 that lacks seedlings; after the seedlings are supplemented, the second blocking and pushing mechanism blocks the seedling containing mechanism 2 that is supplemented with the seedlings on the endless conveyor belt 1, and pushes and transfers the seedling containing mechanism 2 that is supplemented with the seedlings to the endless conveyor belt 1; and
S3: after the endless conveyor belt 1 conveys the seedling containing mechanism 2 to an appropriate position, the flipping mechanism opens the seedling outlet, to complete seedling dropping of the transplanter.

First, all of the seedling containing mechanisms 2 on the U-shaped conveyor belt 9 are loaded with seedlings suitable for transplanting. Then, an existing seedling collecting mechanism drops the seedlings in a seedling raising disk into the plurality of seedling containing mechanisms 2 that are equally distributed on the endless conveyor belt 1. The endless conveyor belt 1 drives the seedling containing mechanisms 2 to continuously move. When the seedling containing mechanism 2 approaches the image collection position sensor 4, the image collection position sensor 4 monitors a position of the seedling containing mechanism 2 in real time and feeds back information to the controller. The controller controls the detection camera 15 to collect an image of the passing seedling containing mechanism 2. The controller identifies whether the seedling cup 201 lacks seedlings or has a high-quality seedling based on the image from the detection camera 15. If there is a high-quality seedling in the seedling cup 201, the lead screw motor 1101 is started, and the sliding block 1106 moves upward to drive the blocking plate 1107 to rotate around a hinge point between the blocking plate and the chute boss 1104. When the blocking component is in a passing state, the seedling containing mechanism 2 normally moves with the endless conveyor belt 1. When the seedling containing mechanism 2 approaches a seedling dropping point, the seedling dropping position sensor 16 detects a position of the seedling containing mechanism 2 in real time, and feeds back information to the controller. The controller controls a cover opening motor 202 mounted on the seedling cup 201 to start, and the crank 211 rotates under the action of the cover opening motor 202 to drive the connecting rod 209 to move to push open the cover plate 208. In this case, a plug seedling in the seedling cup 201 falls into a transplanter below under the action of gravity, to complete a planting operation. If the seedling cup 201 does not have a seedling or has a poor-quality seedling, the controller controls the lead screw motor 1101 to start, and the sliding block 1106 moves downward to drive the blocking plate 1107 to rotate around a hinge point between the blocking plate 1107 and the chute boss 1104. The blocking component is in a blocking state, the seedling containing mechanism 2 remains in the first arc-shaped groove formed by the two first arc-shaped slots, and then, the micro cylinder 1108 is started to drive the arc-shaped push block 1110 to move forward to push the seedling containing mechanism 2 to move backward to a corresponding position where the pushing mechanism 10 can push. Then, the push cylinder 1013 is started to push the T-shaped plate 1012 and the slider 1003 to perform linear motion on the linear guide track 1002 to move forward. The claw 1006 moves forward to cooperate with the wheel axle 205 of the seedling holding mechanism 2. In this case, the lead screw motor 1011 is started, the claw 1006 is pushed to continue to move forward by transmitting power through the first coupling 1010, and the seedling holding mechanism 2 is pushed onto the track change component 6 under push of the horizontal moving module. When the seedling holding mechanism 2 is pushed to the track change component 6, the track change component 6 drives the seedling holding mechanism 2 to move onto the U-shaped conveyor belt 9, and a seedling suitable for transplanting is manually dropped into the seedling cup 203. The U-shaped conveyor belt 9 transfers the seedling containing mechanism 2 on the other side to a normally closed blocking component on the other side. The same process is performed by the second push component 10 cooperating with the track change component 6 to push the seedling containing mechanism 2 with a seedling to the endless conveyor belt 1. When the seedling containing mechanism 2 approaches a seedling dropping point, the seedling dropping position sensor 16 detects a position of the seedling containing mechanism 2 in real time, and feeds back information to the controller. The controller controls the cover opening motor 202 mounted on the seedling cup 201 to start, the crank 211 rotates under the action of the cover opening motor 202 to drive the connecting rod 209 to move to push open the cover plate 208. In this case, the seedling in the seedling cup 201 falls into the transplanter below under the action of gravity, to complete a transplanting operation.

Certainly, the present disclosure is not limited to the implementation described above, and the following further provides several other implementations based on a design concept of the present disclosure.

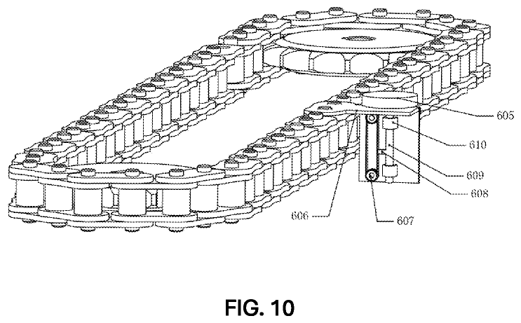

For example, in the second Embodiment, a difference from the implementation described above is that, as shown in FIG. 9 and FIG. 10, in this embodiment, a limiting groove 206 is provided at a lower end of a wheel 204. The track change component 6 includes a reversing plate 601 and two driving components arranged at a lower end of the reversing plate 601. Two limiting portions 602 are provided opposite to each other at an upper end of the reversing plate 601. A through slot for the seedling containing mechanism 2 to pass is formed between the two limiting portions 602. Moving grooves are provided on opposite surfaces of the two limiting portions 602. A plurality of guide wheels 603 are rotatably arranged in the moving grooves, and the guide wheels 603 can be tangent to the wheel 204.

The driving assembly includes a chain and a driving motor, a primary chain that cooperates with the chain is arranged on an output shaft of the driving motor, and a secondary chain that cooperates with the chain is rotatably arranged at a lower end of the reversing plate 601. The chain includes a plurality of chain links. A positioning mechanism is arranged on one of the chain links. The positioning mechanism includes a connecting plate 606 fixed to the chain link, a vertical plate that is arranged on the connecting plate 606 and that forms a 7 shape with the connecting plate 606, and a synchronous belt module arranged on the vertical plate. The synchronous belt module uses an existing synchronous belt module that is commonly used. The synchronous belt module has a synchronous belt. A fixed plate 608 is arranged on the synchronous belt. A guide bushing 610 is further arranged on the vertical plate. A sliding shaft 609 that penetrates through the connecting plate 606 is slidably arranged in the guide bushing 610. A positioning cylinder 605 that cooperates with the limiting groove 206 is provided at an end of the sliding shaft 609. The synchronous belt module may alternatively be a lifting cylinder. The fixed plate 608 is arranged at an end of a piston rod of the lifting cylinder. A rectangular hole 604 for the positioning cylinder 605 to pass through is provided in the reversing plate 601.

When the seedling containing mechanism 2 is pushed into the through slot, the driving component drives the positioning mechanism to move. When the positioning mechanism moves to a lower end of the seedling containing mechanism 2, the synchronous belt module drives the sliding shaft 609 to rise, and the positioning cylinder 605 is clamped into the limiting groove 206. The driving component continues to drive the positioning mechanism to move. When the positioning mechanism moves to a tail end of the rectangular hole 604, the seedling containing mechanism 2 remains at the tail end of the rectangular hole 604, the positioning cylinder 605 departs from an interior of the limiting groove 206, and then the foregoing operations are repeated. A next seedling containing mechanism 2 that changes tracks collides the seedling containing mechanism 2 onto another conveyor belt, to complete a track changing operation.

In some embodiments, the second push component may have an alternative embodiment with a difference from the implementation described above. For example, as shown in FIG. 8, a micro electric push rod 1009 is arranged at an upper end of the horizontal positioning portion. Two arc-shaped sink grooves are symmetrically provided in the claw 1006. Sliding rods are slidably arranged in the arc-shaped sink grooves. A sliding claw 1007 is arranged at an upper end of the sliding rod. Two arc-shaped sliding tracks are symmetrically arranged at an upper end of the claw 1006. A sliding table is arranged on the arc-shaped sliding rail. The sliding claw 1007 is mounted on the sliding table. An end of the micro electric push rod 1009 is hinged to two hinge rods 1008. The hinge rod on the same side is hinged to the sliding claw 1007 on the same side. The micro electric push rod 1009 pushes the sliding claw 1007 to move, to limit the wheel axle 205 and ensure pushing stability.

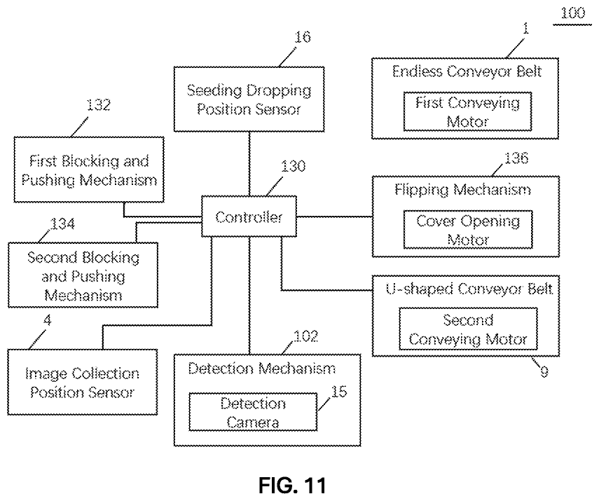

FIG. 11 is a schematic diagram of a double-track seedling separating device for a transplanter, illustrating electrical connections among components according to one embodiment of the present disclosure. Referring to FIG. 11 and with further reference to FIG. 1 and FIG. 2, the double-track seedling separating device includes a controller 130. The controller 130 is electrically connected to the flipping mechanism 136, the image collection position sensor 4, the seedling dropping position sensor 16, the detection mechanism 102, the endless conveyor belt 1, the U-shaped conveyor belt 9, the first blocking and pushing mechanism 132, and the second blocking and pushing mechanism 134.

It is to be noted that the foregoing embodiments are merely used for describing the present disclosure, but the present disclosure is not limited to the foregoing embodiments. Any simple alteration, equivalent change, or modification made to the above embodiments according to the technical essence of the present disclosure fall within the protection scope of the present disclosure.

What is claimed is:

1. A double-track seedling separating device for a transplanter, comprising: a seedling separating frame (3) and a seedling supplement frame (7), wherein an endless conveyor belt (1) is arranged on the seedling separating frame (3), the endless conveyor belt (1) is racetrack-shaped, a plurality of seedling containing mechanisms (2) are placed on the endless conveyor belt (1), a detection mechanism is further arranged on the seedling separating frame (3), the detection mechanism is arranged right above a moving path of the seedling containing mechanism (2), and the detection mechanism is configured to detect whether the seedling containing mechanism (2) located right below the detection mechanism lacks seedlings;
the seedling containing mechanism (2) comprises a seedling cup (201) configured to store a seedling, a seedling outlet is provided at a lower end of the seedling cup (201), the seedling outlet is located on an outer side of the endless conveyor belt (1), a cover portion is arranged at the seedling outlet of the seedling cup (201), and a flipping mechanism configured to drive the cover portion to open or close the seedling outlet is arranged on the seedling cup (201);
a U-shaped conveyor belt (9) is arranged on the seedling supplement frame (7), the U-shaped conveyor belt (9) has an input end and an output end, the input end and the output end of the U-shaped conveyor belt (9) are separately connected to the endless conveyor belt (1) through a first blocking and pushing mechanism and a second blocking and pushing mechanism, the first blocking and pushing mechanism and the second blocking and pushing mechanism are symmetrically arranged, the first blocking and pushing mechanism is configured to block the seedling containing mechanism (2) that lacks seedlings on the endless conveyor belt (1) and push and transfer the seedling containing mechanism (2) that lacks seedlings to the U-shaped conveyor belt (9), a manual supplement position is provided on one side of the U-shaped conveyor belt (9), the manual supplement position is configured to manually supplement seedlings to the seedling containing mechanism (2) that lacks seedlings, and the second blocking and pushing mechanism is configured to block the seedling containing mechanism (2) that lacks seedlings on the endless conveyor belt (1), and push and convey the seedling containing mechanism (2) after the seedlings are supplemented to the endless conveyor belt (1);
the seedling containing mechanism (2) comprises a seedling cup fixing plate (203), two wheel axles (205) arranged at a lower end of the seedling cup fixing plate (203), and wheels (204) fixedly arranged at lower ends of the wheel axles (205), and a mounting slot for mounting the seedling cup (201) is provided on the seedling cup fixing plate (203);
the first blocking and pushing mechanism and the second blocking and pushing mechanism are of the same structure and size, the first blocking and pushing mechanism comprises a blocking component, a first push component (5), a second push component (10), and a track change component (6), the first push component (5) is arranged on the blocking component, and the blocking component has two states of blocking and passing; in a blocking state, the blocking component blocks the seedling containing mechanism (2), the first push component

(5) is configured to push the seedling containing mechanism (2) to the second push component (10), the second push component (10) is configured to push the seedling containing mechanism (2) to the track change component (6), the track change component (6) is configured to transfer the seedling containing mechanism (2) to the U-shaped conveyor belt (9); when the seedlings are placed, the seedling containing mechanism (2) can pass through the blocking component;
the blocking component comprises two blocking pieces (11) that are arranged opposite to each other, the blocking piece (11) comprises a vertical moving module, blocking plates (1107) are hinged to the vertical moving module, first arc-shaped slots are oppositely provided on the two blocking plates (1107), the two first arc-shaped slots form a first arc-shaped groove that cooperates with the wheel axles (205), the vertical moving module comprises a chute boss (1104), a lead screw motor (1101), a lead screw (1103), and a sliding block (1106), the lead screw (1103) is rotatably arranged on the chute boss (1104), the lead screw motor (1101) is configured to drive the lead screw (1103) to rotate, the sliding block (1106) is slidably arranged on the chute boss (1104) and is in threaded connection with the lead screw (1103), a connecting plate (1105) is hinged between the sliding block (1106) and the blocking plate (1107), the first push component (5) comprises a micro cylinder (1108) arranged on the blocking plate (1107), an arc-shaped push block (1110) is arranged at an end of a piston rod of the micro cylinder (1108), the arc-shaped push block (1110) has second arc-shaped slots, and the two second arc-shaped slots form a second arc-shaped groove that cooperates with the wheel axles (205); and
the second push component (10) comprises a fixed bottom plate (1001), a T-shaped plate (1012) slidably arranged on the fixed bottom plate (1001), and a push cylinder (1013) configured to drive the T-shaped plate (1012) to move horizontally, a T-shaped plate is arranged on a bearing plate (1014), a horizontal moving module perpendicular to the T-shaped plate is arranged on the T-shaped plate, two horizontal moving modules are provided, the horizontal moving modules are arranged parallel to the fixed bottom plate (1001), a claw (1006) that cooperates with the wheel axle (205) is arranged on the horizontal moving module, and the claw (1006) is in a semicircular shape.

2. The double-track seedling separating device for a transplanter according to claim 1, wherein the detection mechanism comprises a mounting truss (13) arranged on the seedling separating frame (3), a fixed bracket (14) arranged on the mounting truss (13), and a detection camera (15) arranged at a lower end of the fixed bracket (14), the detection camera (15) is connected to a controller, and the detection camera (15) can take a photo of the seedling containing mechanism (2) located below the detection camera (15), to enable the controller to identify whether the seedling containing mechanism (2) lacks seedlings.

3. The double-track seedling separating device for a transplanter according to claim 1, wherein the cover portion comprises two cover plates (208) hinged at the seedling outlet, the flipping mechanism comprises a cover opening motor (202) and a connecting rod component arranged on an inner side of the seedling cup (201), a partition (207) configured to divide an inner cavity of the seedling cup (201) into an accommodating cavity and a connecting rod cavity is arranged in the seedling cup (201), the accommodating cavity is configured to accommodate the seedlings, the connecting rod component is located in the connecting rod cavity, the connecting rod component comprises a crank (210) arranged at an output shaft of the cover opening motor (202), a connecting rod (209) is hinged to the cover plate (208), and both the connecting rods (209) are hinged to the crank (210).

4. The double-track seedling separating device for a transplanter according to claim 1, wherein the track change component (6) comprises a horizontal conveyor belt.

5. An operation method for a double-track seedling separating device for a transplanter by using the double-track seedling separating device for a transplanter according to claim 1, comprising the following steps:
S1: placing the plurality of seedling containing mechanisms (2) on the endless conveyor belt (1), and detecting, by using the detection mechanism, whether the seedling containing mechanism (2) located right below the detection mechanism lacks seedlings;
S2: when lack of seedling is not detected by the detection mechanism, continuously conveying, by using the endless conveyor belt (1), the seedling containing mechanism (2); when lack of seedling is detected by the detection mechanism, blocking, by using the first blocking and pushing mechanism, the seedling containing mechanism (2) that lacks seedlings on the endless conveyor belt (1), pushing and transferring the seedling containing mechanism (2) that lacks seedlings to the U-shaped conveyor belt (9), and then manually supplementing seedlings to the seedling containing mechanism (2) that lacks seedlings; after the seedlings are supplemented, blocking, by using the second blocking and pushing mechanism, the seedling containing mechanism (2) that is supplemented with the seedlings on the endless conveyor belt (1) and pushing and transferring the seedling containing mechanism (2) that is supplemented with the seedlings to the endless conveyor belt (1); and
S3: after the endless conveyor belt (1) conveys the seedling containing mechanism (2) to an appropriate position, opening the seedling outlet by using the flipping mechanism, to complete seedling dropping of the transplanter.
